(19) United States
(12) Patent Application Publication
(10) Pub. No.: US 2024/0403518 A1
(43) Pub. Date: Dec. 5, 2024

(54) METHOD AND SYSTEM FOR RANDOMLY GENERATING POROUS MEDIUM MODEL

(71) Applicant: Harbin Institute of Technology, Harbin (CN)

(72) Inventors: Wei GUAN, Harbin (CN); Yan ZHOU, Harbin (CN); Chao ZHANG, Harbin (CN); Jun WANG, Harbin (CN); Hengshan HU, Harbin (CN)

(21) Appl. No.: 18/642,930

(22) Filed: Apr. 23, 2024

(30) Foreign Application Priority Data
Jun. 2, 2023 (CN) 202310647223.6

(51) Int. Cl. G06F 30/25; G06F 111/10; G06F 113/08

(52) U.S. Cl. CPC G06F 30/25; G06F 2111/10; G06F 2113/08

(57) ABSTRACT

Provided are a method and a system for randomly generating a porous medium model. The method includes following steps: setting a porosity, resolution and a size of a pre-generated porous medium model; initializing the porous medium model and generating position information of particles; extracting particle profile edges; obtaining filled particles; carrying out a collision detection on the filled particles and preset particles, and determining effectiveness of a particle generation position; presetting a cyclic pop-up condition, and if a judgment result meets the cyclic pop-up condition, continuing; otherwise, updating Fourier parameters; adding a particle configuration meeting the cyclic pop-up condition to a model generation area, and storing parameters; determining whether the generated model meets preset generation requirements, and if so, outputting a porous medium model.

### CROSS-REFERENCE TO RELATED APPLICATIONS

This application claims priority to Chinese Patent Application No. 202310647223.6, filed on Jun. 2, 2023, the contents of which are hereby incorporated by reference.

### TECHNICAL FIELD

The disclosure belongs to the technical field of porous medium model generation, and particularly relates to a method and a system for randomly generating a porous medium model.

### BACKGROUND

A geological reservoir in which fossil energy such as oil and coalbed methane are located is essentially a complex porous medium structure with particles piled up. Evolving imaging and numerical technologies have propelled pore scale calculation into a pivotal role for scrutinizing the temporal and spatial behaviour of fluids within these reservoirs. At present, Computed Tomography (CT) scanning and digital generation stand out as primary techniques for creating models in pore scale calculations. However, CT scanning has a high cost, a low efficiency, and a large sample limitation in sample size, restricting its ability to yield a diverse range of models for comprehensive universal studies techniques, such as the random field and particle accumulation models provides alternative avenues. The random field model can generate porous media adhering to a Minkowski function, but it is difficult to ensure connectivity of the model in low porosity models critical for pore scale simulation. At the same time, the random field model is difficult to accurately restore a complex configuration of particles in the geological reservoir. On the other hand, the particle accumulation model transforms original spherical particles into irregular shapes, and the particle accumulation model gradually mimicking real porous structures. Aiming at generation of the irregular particles, main methods are a composite particle method and a single particle method. In the composite particle method, clusters of disks/spheres are used to approximate the irregular particles. Although a cluster method provides flexibility in modeling particles of various shapes, inherent unrealistic multiple sub-contacts may produce generation errors. Conversely, the single particle method employs closed curves or surfaces to replicate shapes like ellipses/ellipsoids, hyperquadrics, polygons/spheres/polyhedrons, non-uniform rational basis splines. Techniques such as the level set function and the Fourier series theoretically enable the reproduction of any particle shape. However, the level set function is computationally expensive and requires a considerable storage space. In contrast, the Fourier series rely on shape and position descriptors and proves more storage-efficient while accurately representing particle morphology laying a solid groundwork for intricate pore-scale modeling. Although the Fourier series shows a good numerical performance in particle reconstruction, a collision detection during the particle accumulation remains a difficult problem to solve.

The disclosure provides a method and a system for randomly generating a porous medium model for reconstructing and generating the porous medium model.

### SUMMARY

The following is an overview to the subject described in detail herein. This overview is not intended to limit the scope of protection of the claims.

An objective of the disclosure is to solve the shortcomings of the prior art and provides a method and a system for randomly generating a porous medium model for simulating geological reservoirs. This method well combines advantages of the Fourier series in generating irregular particle shapes, and on this basis, develops particle filling and collision detection algorithms, and enabling the generation of interconnected porous media theoretically approaching near-zero porosity.

In order to achieve the above objective, the disclosure provides a following scheme.

A method for randomly generating a porous medium model for simulating geological reservoirs, implemented in a computer system using a set of computer-executable instructions, includes following steps:
S1, drilling various spatial positions in the geological reservoir to determine geological reservoir-related behavior information and collecting measurements of plurality of mined samples using a data collection device in the laboratory;
S2, setting a porosity, resolution and a size of a pre-generated porous medium model designed for a specific geological reservoir;
S3, initializing the porous medium model by incorporating a geological data and generating position information of particles based on said data;
S4, performing a Fourier series expansion based on the setting of the S2 and the geological data to obtain a particle profile parameter equation of a porous medium, and discretizing to obtain discrete particle profile data;
S5, performing grid mapping on the discrete particle profile data to extract particle profile edges;
S6, carrying out local marking and area search on the particle profile edges to obtain filled particles;
S7, carrying out a collision detection on the filled particles and preset particles, and determining effectiveness of a particle generation position;
S8, presetting a cyclic pop-up condition, and using the computer to determine an optimal particle shape in relation to the discrete particle profile data and porosity with Fourier series expansion, then adding a particle configuration meeting the cyclic pop-up condition to a model generation area, and storing parameters; and
S9, constructing the porous medium model with the optimal particle shape using the computer, and repeating the porous medium model generated in the S8 until meets preset generation requirements, and outputting a porous medium model, and at least one of recording and tabulating results of the repeated model and calculating.

Optionally, parameters of the initialization include a model porosity and a model size; and
the position information includes position coordinates and rotation angles of particle centres.

Optionally, a method of obtaining the parameter equation is:
establishing a global coordinate system representing a pore space and a local coordinate system representing a particle space;
based on the local coordinate system, expanding the Fourier series to obtain a single-valued function;
based on the single-valued function, obtaining a particle profile parameter equation of the local coordinate system;
converting the particle profile parameter equation of the local coordinate system into a particle profile parameter equation of the global coordinate system; and
based on the particle profile parameter equation of the global coordinate system, obtaining the particle profile parameter equation of the porous medium.

Optionally, a formula of the single-valued function is:

$$r ( {θ}^{′} ) = {a}_{0} + {\sum }_{n = 1}^{N} [ {a}_{n} cos ( n {θ}^{′} ) + {b}_{n} sin ( n {θ}^{′} ) ] ,$$

where r represents a radius from a particle center point P to a point P′ on the profile; θ′ represents a polar angle of a radius of an x′ axis of the local coordinate system x′-y′, 0≤θ′<2π; a₀, aₙ, bₙ and N are Fourier coefficients.

Optionally, the particle profile parameter equation of the local coordinate system is as follows:

x′(θ′)=r(θ′)cos θ′

y′(θ′)=r(θ′)sin θ′

The particle profile parameter equation of the global coordinate system is as follows:

$$x = {x}_{p} + {x}^{′} ( {θ}^{′} ) cos ( {θ}_{0} ) = {x}_{p} + r ( {θ}^{′} ) cos ( θ )$$

$$y = {y}_{p} + {y}^{′} ( {θ}^{′} ) sin ( {θ}_{0} ) = {y}_{p} + r ( {θ}^{′} ) sin ( θ )$$

where xₚ and yₚ are translation distances of the particle center in the global coordinate system, a variable θ₀ is an angle from the global coordinate system x axis to the local coordinate system x′ axis, and θ=θ₀+θ′ represents a polar angle of a point in the global coordinate system.

Optionally, a method for the collision detection is:
adding a porous medium corresponding area and a grid area in a matrix, and determining whether an abnormal value exists; and
if the abnormal value exists, there is a local intersection of marked points to realize the collision detection.

Optionally, in the step S8, the Fourier parameters are updated by adopting a Floyd-Warshall algorithm;
an iterative equation of the Floyd-Warshall algorithm is:

$$\{ \begin{matrix}{u}_{i , i}^{( 1 )} = 0 \\ {u}_{j , j}^{( 1 )} = {w}_{i , j} , i \neq j \\ {u}_{i , j}^{( k + 1 )} = min \{ {u}_{i , j}^{( k )} , {u}_{i , k}^{( k )} + {u}_{k , j}^{( k )} \} , i , j , k = 1 , 2 , … , n\end{matrix}$$

where w_{i,j} represents a path length value from a node i to a node j.

Optionally, a solution method for the iterative equation is:
S71: initializing equation parameters, k=0, and letting p_{i,j}⁽¹⁾=j, u_{i,j}⁽¹⁾=0 and u_{i,j}⁽¹⁾=w_{i,j} for all nodes i and j, where i≠j; if there is no arc connection between the node i and the node j, then w_{i,j}=∞;
S72: letting k=k+1, for all inflow nodes i and outflow nodes j adjacent to a k node, if u_{i,j}^{(k)}≤u_{i,k}^{(k)}+u_{k,j}^{(k)}, letting p_{i,j}^{(k)}=p_{i,j}^{(k)}, u_{i,j}^{(k+1)}=p_{i,j}^{(k)}; otherwise, letting p_{i,j}^{(k+1)}=p_{i,j}^{(k)}, u_{i,j}^{(k+1)}=u_{i,k}^{(k)}+u_{k,j}^{(k)}; and
S73: if k=n, completing a solution; otherwise, returning to the S72.

The disclosure also provides a system for randomly generating a porous medium model, including a model acquisition module, an initialization module, a discrete module, an edge extraction module, a filling module, a collision detection module, an update module, a model generation module and an output module.

The model acquisition module is used for setting a porosity, resolution and a size of a pre-generated porous medium model.

The initialization module is used for initializing the porous medium model and generating position information of particles; parameters of the initialization include a model porosity and a model size; and the position information includes position coordinates and rotation angles of particle centers.

The discrete module is used for generating and combining Fourier parameters based on setting of the initialization module and a Fourier series expansion, obtaining a particle profile parameter equation of a porous medium, and performing discretization to obtain discrete particle profile data; and a process of obtaining the parameter equation is:
establishing a global coordinate system representing a pore space and a local coordinate system representing a particle space;
based on the local coordinate system, expanding the Fourier series to obtain a single-valued function;
based on the single-valued function, obtaining a particle profile parameter equation of the local coordinate system;
converting the particle profile parameter equation of the local coordinate system into a particle profile parameter equation of the global coordinate system; and
based on the particle profile parameter equation of the global coordinate system, obtaining the particle profile parameter equation of the porous medium.

The edge extraction module is used for carrying out grid mapping on the discrete particle profile data and extracting particle profile edges.

The filling module is used for carrying out local marking and area search on the particle profile edges to obtain filled particles.

The collision detection module is used for carrying out a collision detection on the filled particles and preset particles, and determining effectiveness of a particle generation position.

The update module is used for presetting a cyclic pop-up condition, and if a judgment result of the collision detection module meets the cyclic pop-up condition, executing the model generation module; otherwise, updating the Fourier parameters and returning to the update module.

The model generation module is used for adding a particle configuration meeting the cyclic pop-up condition to a model generation area and storing the parameters.

The output module is used for determining whether the porous medium model generated in the model generation module meets preset generation requirements, and if so, outputting a porous medium model; otherwise, returning to the initialization module.

Compared with the prior art, the disclosure has following beneficial effects.

The disclosure provides a porous medium generation method. The method utilizes advantages of the Fourier series in describing particle shape parameters with a low storage cost, and carries out fine modeling by adjusting a Fourier parameter N. For example, surface roughness of particles may be described at a high frequency and particle shapes may be described at a low frequency. At the same time, this method may use grid mapping to transform a problem from continuous to discrete, which is helpful for particle profile filling and a contact detection. In a contact detection method, the Floyd-Warshall algorithm is introduced to update feasible parameters without changing particle shape descriptors. An addition of this algorithm greatly improves a calculation speed of this method, and may complete reconstruction of a single particle in two cycles at most.

### BRIEF DESCRIPTION OF THE DRAWINGS

In order to explain technical schemes of the present invention more clearly, drawings needed in embodiments are briefly introduced below. Obviously, the drawings in a following description are only some embodiments of the present invention. For ordinary people in the field, other drawings may be obtained according to these drawings without paying a creative labor.

FIG. 1 is a schematic flow chart of a method for randomly generating a porous medium model according to Embodiment 1 of the disclosure.

FIG. 2 is a geometric representation of irregular particle profiles in local and global coordinate systems according to Embodiment 1 of the disclosure.

FIG. 3 is a visualization of generation of a two-parameter equation according to Embodiment 2 of the disclosure.

FIG. 4 is a visualization of a discrete parameter equation according to Embodiment 2 of the disclosure.

FIG. 5 is a schematic diagram of a particle edge extraction process according to Embodiment 2 of the disclosure.

FIG. 6 is a schematic diagram of particle filling in Embodiment 2 of the disclosure.

FIG. 7 shows a geometric model of a porous medium by a method in Embodiment 2 of the disclosure.

FIG. 8 is a comparison of sphericity and convexity between 50 randomly selected particles from 236 generated particles and 100 natural sand particles in Embodiment 2 of the disclosure.

### DETAILED DESCRIPTION OF THE EMBODIMENTS

In the following, the technical scheme in the embodiment of the disclosure will be clearly and completely described with reference to the attached drawings. Obviously, the described embodiment is only a part of the embodiment of the disclosure, but not the whole embodiment. Based on the embodiments in the disclosure, all other embodiments obtained by ordinary technicians in the field without creative labor belong to the scope of protection of the disclosure.

In order to make the above objects, features and advantages of the disclosure more obvious and easier to understand, the disclosure will be further described in detail with the attached drawings and specific embodiments.

### Embodiment 1

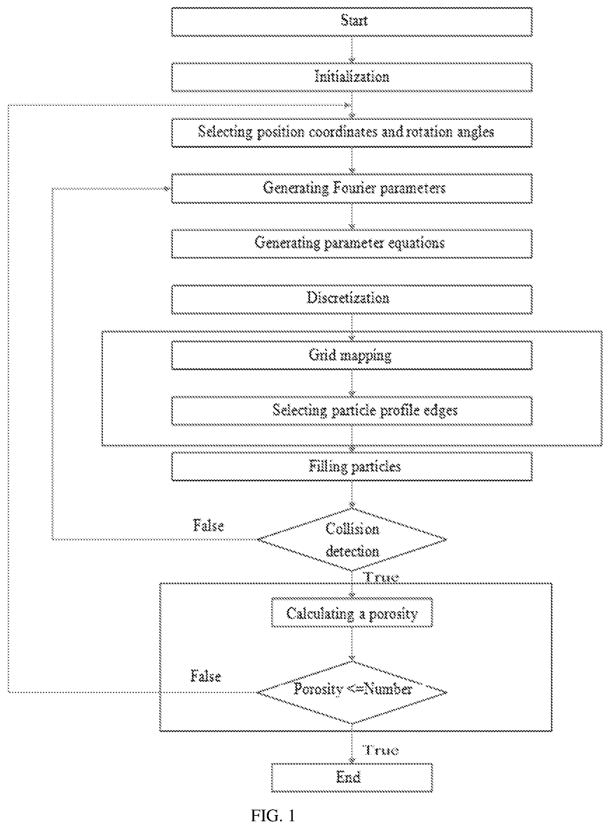

As shown in FIG. 1, a method for randomly generating a porous medium model includes following steps:
S1, setting a porosity, resolution and a model size of a pre-generated porous medium model;
S2, generating position information including position coordinates and a rotation angle of a particle center; and
S3, based on the setting of the S2 and a Fourier series expansion, generating and combining Fourier parameters to obtain a particle profile parameter equation of a porous medium, and discretizing to obtain discrete particle profile data.

A method for obtaining the parameter equation is:

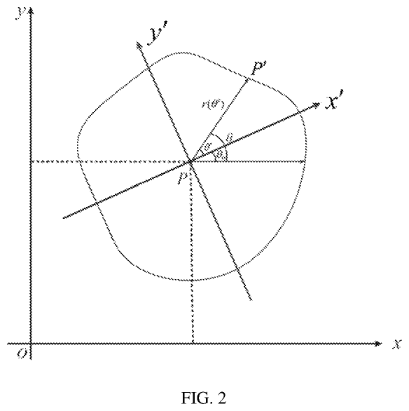

As shown in FIG. 2, establishing a global coordinate system x-y representing a pore space and a local coordinate system x′-y′ representing a particle space;

Based on the local coordinate system, expanding Fourier series to obtain a single-valued function;
a formula of the single-valued function is:

$$r ( {θ}^{′} ) = {a}_{0} + {\sum }_{n = 1}^{N} [ {a}_{n} cos ( n {θ}^{′} ) + {b}_{n} sin ( n {θ}^{′} ) ] ,$$

where r represents a radius from a particle center point P to a point P′ on the profile; θ′ represents a polar angle of a radius of an x′ axis of the local coordinate system x′-y′, 0≤θ′<2π; a₀, aₙ, and bₙ are Fourier parameters. a₀, aₙ, and bₙ jointly determine a particle size, and N is an order of Fourier series expansion, which determines a particle shape.

Based on an experimental statistical analysis, a distribution range and a distribution pattern of the particle size in the porous medium are known (for example, normal, lognormal and bimodal normal). With a help of these results, the Fourier parameters (a₀, aₙ, and bₙ) that determine the particle size are randomly generated and follow the distribution pattern. Random generation of the Fourier parameter N enables a setting of particle morphology. For particle morphology, if a research object is a particle shape, the Fourier parameter N is generated randomly in a low frequency range. If the research object is a surface roughness of a particle, the Fourier parameter N must be generated randomly at a high frequency range.

Based on the single-valued function, a particle profile parameter equation of the local coordinate system is obtained. Specifically, the particle profile parameter equation of the local coordinate system x′-y′ is also expressed by mapping coordinates in horizontal and vertical coordinates and using the Fourier series as a function of θ′:
the particle profile parameter equation of the local coordinate system is as follows:

x′(θ′)=r(θ′)cos θ′

y′(θ′)=r(θ′)sin θ′

The particle profile parameter equation of the local coordinate system is converted into a particle profile parameter equation of the global coordinate system. A position of the particle is transformed from the local coordinate system to the global coordinate system.

The particle profile parameter equation of the global coordinate system is as follows:

$$x = {x}_{p} + {x}^{′} ( {θ}^{′} ) cos ( {θ}_{0} ) = {x}_{p} + r ( {θ}^{′} ) cos ( θ )$$

$$y = {y}_{p} + {y}^{′} ( {θ}^{′} ) sin ( {θ}_{0} ) = {y}_{p} + r ( {θ}^{′} ) sin ( θ )$$

where xₚ and yₚ are translation distances of the particle center in the global coordinate system, a variable θ₀ is an angle from the global coordinate system x axis to the local coordinate system x′ axis, and θ=θ₀+θ′ represents a polar angle of a point in the global coordinate system. Through the above equations, any particle shape and spatial position information may be fully described by the Fourier parameters, translation (xₚ and yₚ) and the rotation (θ₀).

Based on the particle profile parameter equation of global coordinate system, the particle profile parameter equation of the porous medium is obtained.

The parameter equation is dispersed according to a certain step size, and the step size is usually small, otherwise an accuracy may not be guaranteed. The step size is related to grid resolution to ensure that at least one point in each grid is discretized by the parameter equation.

S4, grid mapping is carried out on discrete particle profile data to extract particle profile edges.

The particle profile is extracted by projecting discrete points onto the grid. When extracting the particle profile, only grid points in a preset rectangular area must be compared with the discrete points to improve a running speed of a program. A size of a rectangular area may be determined by minimum and maximum values of discrete points in the x and y directions, including └xₘᵢₙ┘, ┌xₘₐₓ┐, └yₘᵢₙ┘, and ┌yₘₐₓ┐, where corresponding discrete points are P₁(xₘᵢₙ, y_{P1}), P₂(xₘₐₓ, y_{P2}), P₃(x_{P3}, yₘᵢₙ), and P₄(xₚ₄, yₘₐₓ). These discrete points are recorded and the rectangular area is divided into four areas. Sizes of these areas are as follows:

$$Region 1 = ( ⌈ {x}_{P 4} ⌉ - ⌊ {x}_{min} ⌋ ) \times ( ⌈ {x}_{P 4} ⌉ - ⌊ {x}_{min} ⌋ ) ,$$

$$Region 2 = ( ⌈ {x}_{max} ⌉ - ⌊ {x}_{P 4} ⌋ ) \times ( ⌈ {y}_{max} ⌉ - ⌊ {y}_{P 1} ⌋ ) ,$$

$$Region 3 = ( ⌈ {x}_{P 3} ⌉ - ⌊ {x}_{min} ⌋ ) \times ( ⌈ {y}_{P 1} ⌉ - ⌊ {y}_{min} ⌋ ) ,$$

$$Region 4 = ( ⌈ {x}_{max} ⌉ - ⌊ {x}_{P 3} ⌋ ) \times ( ⌈ {y}_{P 2} ⌉ - ⌊ {y}_{min} ⌋ ) .$$

Then, grid points in each of the four areas are traversed to compare these values with the corresponding discrete points, and if an area bounded by the grid points aₙ(xₙ, yₙ) and a″ₙ(xₙ+γₓ, yₙ−γ_{y}) has a discrete point a′ₙ(x′ₙ, y′ₙ), the area is marked as a particle profile; otherwise, it is not. γₓ and γ_{y} represent the dimensions in the x direction and the y direction of each grid point, respectively. A method for determining whether there are discrete points in the four areas is as follows:

$$Region 1 : {x}_{n} \leq {x}_{n}^{′} \& {y}_{n} \geq {y}_{n}^{′} \& {x}_{n} + {γ}_{x} \geq {x}_{n}^{′} \& {y}_{n} - {γ}_{y} \leq {y}_{n}^{′} ,$$

$$Region 2 : {x}_{n} \geq {x}_{n}^{′} \& {y}_{n} \geq {y}_{n}^{′} \& {x}_{n} - {γ}_{x} \leq {x}_{n}^{′} \& {y}_{n} - {γ}_{y} \leq {y}_{n}^{′} ,$$

$$Region 3 : {x}_{n} \leq {x}_{n}^{′} \& {y}_{n} \geq {y}_{n}^{′} \& {x}_{n} + {γ}_{x} \geq {x}_{n}^{′} \& {y}_{n} + {γ}_{y} \geq {y}_{n}^{′} ,$$

$$Region 4 : {x}_{n} \geq {x}_{n}^{′} \& {y}_{n} \leq {y}_{n}^{′} \& {x}_{n} - {γ}_{x} \leq {x}_{n}^{′} \& {y}_{n} + {γ}_{y} \geq {y}_{n}^{′} .$$

S5, local marking and area search are carried out on the particle profile edges to obtain filled particles. Specifically, the particle profile is filled to form a single particle. If x coordinate values of the marked grid points are discontinuous, the marked grid points along the y direction in the step S4 are selected and marked separately. At this point, a problem of generating particles method is transformed from continuous to discrete to facilitate a contact detection.

S6, a collision detection is performed on the filled particles and preset particles, and effectiveness of a particle generation position is judged.

S7, a cyclic pop-up condition is preset, and if a judgment result of the S6 meets the cyclic pop-up condition, proceed to S8. Otherwise, the Fourier parameters are updated and return to S3.

Collision detection is performed to determine whether the generated particles overlap. For collision detection, if the judgment result is true, Floyd-Warshall algorithm is executed, and the parameter equation is entered to update Fourier parameters, and the steps S3-S5 are repeated. If the result is false, S7 is executed. Using Floyd-Warshall algorithm, Fourier parameters may be corrected in time. At most, two cycles may be executed to generate particles satisfying contact detection, thus greatly reducing the complexity of the program.

An embedding of a Floyd-Warshall algorithm optimizes a calculation time and complexity of a whole model. A core idea is that an essence of a shortest path is to compare a transit point between two vertices and compare a distance between passing through and not passing through the transit point. The core idea is that the essence of the shortest path is to compare the transit point between the two vertices and compare the distance between passing through and not passing through the transit point.

Specifically, a collision detection method is:
adding a porous medium corresponding area and a grid area in a matrix, and determining whether an abnormal value exists; and
if there is an abnormal value, there is a local intersection of marked points to realize collision detection.

In the step S7, the Fourier parameters are updated by adopting a Floyd-Warshall algorithm;
an iterative equation of the Floyd-Warshall algorithm is:

$$\{ \begin{matrix}{u}_{i , i}^{( 1 )} = 0 \\ {u}_{j , j}^{( 1 )} = {w}_{i , j} , i \neq j \\ {u}_{i , j}^{( k + 1 )} = min \{ {u}_{i , j}^{( k )} , {u}_{i , k}^{( k )} + {u}_{k , j}^{( k )} \} , i , j , k = 1 , 2 , … , n\end{matrix}$$

where wᵢ represents a path length value from a node i to a node j.

A solution method for the iterative equation is:
S71: initializing equation parameters, k=0, and letting p_{i,j}⁽¹⁾=j, u_{i,j}⁽¹⁾=0 and u_{i,j}⁽¹⁾=w_{i,j} for all nodes i and j, where i j; if there is no arc connection between the node i and the node j, then w_{i,j}=∞;
S72: letting k=k+1, for all inflow nodes i and outflow nodes j adjacent to a k node, if u_{i,j}^{(k)}≤u_{i,k}^{(k)}+u_{k,j}^{(k)}, letting p_{i,j}^{(k)}=p_{i,j}^{(k)}, u_{i,j}^{(k+1)}=p_{i,j}^{(k)}; otherwise letting p_{i,j}^{(k+1)}=p_{i,j}^{(k)}, u_{i,j}^{(k+1)}=u_{i,k}^{(k)}+u_{k,j}^{(k)}; and
S73: if k=n, completing a solution; otherwise, returning to S72.

S7, a particle configuration meeting the cyclic pop-up condition is added to a model generation area, and the parameters are stored; specifically, the stored parameters include particle position coordinates, rotation angles and the Fourier parameters; and a porosity is calculated.

S8, whether the porous medium model generated in the S7 meets preset generation requirements is judged, and if so, the porous medium model is output; otherwise, return to S2. If a porosity value is less than a set target value, a cycle is repeated. When the porosity meets design requirements, relevant information of the porous medium model is output.

### Embodiment 2

In order to make the method for randomly generating the porous medium model more convenient to understand and close to a real application, a porous medium model meeting measurement parameters is generated according to previous statistics on the particle shape of the porous medium and referring to previous results. A constraint range is set by a measured particle size range, and a Fourier parameter range is set according to a measured particle shape parameter range. Then, the porous medium model is generated and generated data is saved.

The particle size is usually quantified by a principal axis (d₁) and a minor axis (d₂). In order to calculate the d₁ and the d₂, the principal axis of the particle is first determined, then the particle is rotated to make the principal axis follow the global coordinate system, and then calculation is performed. Values of the d₁ and the d₂ are controlled by a Fourier coefficient which determines the particle size. A ratio α of major dimensions d₁ and d₂ is defined as an aspect ratio of the particle. The ratio α varies from 0 to 1, where 1 represents a round particle, and a value close to 0 represents a very slender particle:

$$α = \frac{{d}_{2}}{{d}_{1}} .$$

Shape descriptors of a generated particle-sphericity (S) and convexity (Cₓ). The sphericity is usually used to indicate approximation of a particle geometry to a perfect circle. The convexity may be defined as an area of the particle divided by an area of a convex hull surrounding the particle.

$$S = \frac{2 \sqrt{π A}}{P} ,$$

$${C}_{x} = \frac{A}{{A}_{c}} ,$$

where A and P represent the area and a perimeter of the particle, respectively. Ac is an area of the convex hull.

Specific operation steps are as follows:
according to the statistics of the particle shape, a value range of a long axis of the particle is 100-300 μm, and it is normally distributed, and a ratio of a short axis to the long axis is distributed between 0.6-1. At the same time, according to a description relationship of the particle by Fourier, an order of the Fourier series is generally between 4 and 7. Therefore, a porous medium model distributed in 5000×3000 μm² with a porosity of 0.24 is generated as an embodiment of the disclosure, and its sphericity and convexity are compared with those of a real particle to verify the effectiveness of program generation.

Step 1: a program is initialized, and key parameters of the program, a porosity and a physical size of the model are set to 0.24 and 5000×3000 μm² respectively, and grid resolution required by the program is set to 50000×30000. This is to make a calculation of the model fine enough.

Step 2: a center position of an expected generated particle is set to be 0<x<5000 and 0<y<3000, and the rotation angle is 0≤θ₀<360. The center position of the particle in this step is generated randomly. When the program is iterated, a range change will be updated in time, and grid cells covered by the particle will be marked. In a process of selecting a generation position, only uncovered particle positions will be generated.

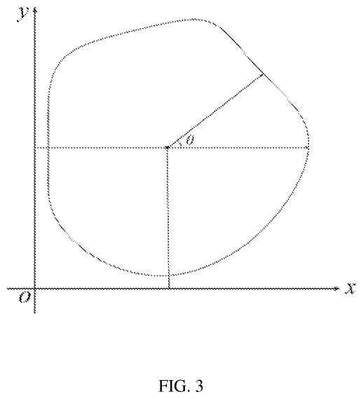

Step 3: according to characteristics of the Fourier series on particle characterization, a range of a long axis of the particle is set to 100-300, and a ratio of a short axis to the long axis is 0.6-1. An above data type is floating point. A value range of Fourier parameters is set to 4-7, where the data type of the Fourier parameters is integer. At the same time, it is necessary to introduce position coordinates and a rotation angle in the step 2 to define a shape of a generated particle configuration, as shown in FIG. 3.

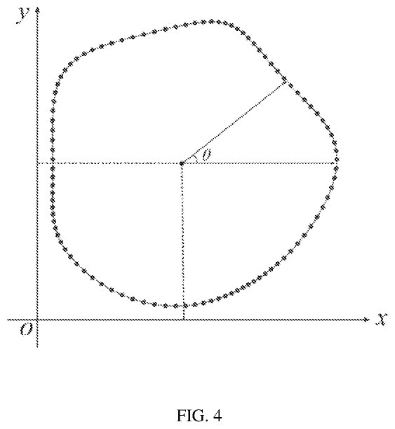

Step 4, a parameter equation of the particle configuration is discretized. According to requirements of discretization, discretization resolution should be smaller than the grid resolution, that is, the grid resolution is 50000×30000, which means at 5000×3000, a smallest cell is 0.1. Therefore, it is necessary to ensure that there is at least one discrete point in a grid cell of 0.1×0.1 when discretizing. Otherwise, a failure to search for effective boundary cells in the grid may be leaded, resulting in continuous edge recognition errors. Here it is set to 5000 points for discretization. Because the points are too dense, FIG. 4 only shows a simplified model.

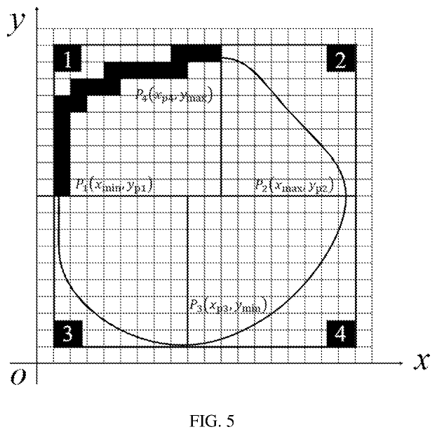

Step 5, a discrete parameter equation is projected into the grid, and particle profile edges are extracted. The position coordinates and the rotation angle generated in the step 2 are retrieved, and the discrete parameter equations are arranged in a grid of 50000*30000. Because the generated position coordinates and the rotation angle are floating points, position information and a grid accuracy are not converted. In this embodiment, it is necessary to enlarge the position by 10 times and round it down to obtain coordinate values in the grid. By doing so, an index of a grid position may be obtained directly, and the position information may be determined conveniently and quickly. At this point, the discrete parameter equation is placed in the grid area. Before edge detection, it is necessary to mark a coverage area of the particle. A marking method is to find maximum values and minimum values of corresponding x and y coordinates in the discrete parameter equation, and the minimum values are rounded down and the maximum values are rounded up. According to this operation, a completely covered grid area of the discrete parameter equation may be obtained. The edge detection is carried out in this area to extract the particle profile edges. Doing so may greatly improve a speed of the edge detection. Then, the edge detection is carried out. Firstly, a marked grid area is divided into four areas. The four areas are determined according to the maximum values and the minimum values of the discrete parameter equation of x and y, and a first area is determined by a minimum value of x and a maximum value of y. In this area, the grid area is traversed from left to right to determine whether there are discrete points of the parameter equation of the area. An operation of this part embeds an idea of program parallelism, which greatly improves a calculation speed. When the edge detection is carried out, for a single grid cell, it is judged whether there are discrete points of the parameter equation of an area surrounded by abscissas x and x+1 and ordinates y and y+1. If there are, the area is marked as a boundary, if not, the area is not a boundary. Other areas are determined according to a maximum value of x and the maximum value of y, the minimum value of x and a minimum value of y, and the maximum value of x and the minimum value of y respectively. Determination methods are similar, but judgment directions have changed. A specific schematic diagram is FIG. 5.

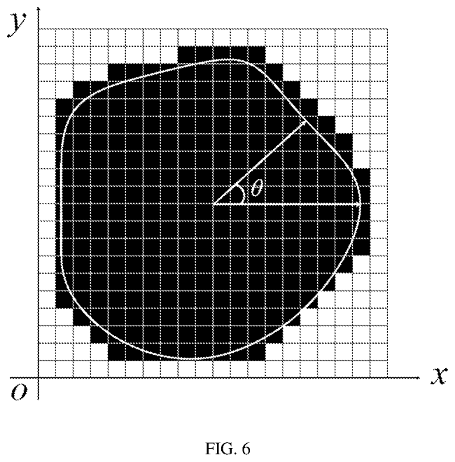

Step 6: according to the boundary extracted in step 5, particle filling is carried out. Boundary information is analyzed to find a maximum value and a minimum value of a y coordinate of a corresponding particle edge. All the x coordinates of this area are traversed and sorted in size at the same time, and all the marked points under this y coordinate may be obtained. Then, through continuity of an array of x coordinates, coordinates of unmarked points are obtained and marked. For example, an arrangement order of the x coordinates is [1,3,4,5,8,9], which means that there are grid positions with the x coordinates of [2,6,7] under the y coordinate that are not marked, so they are marked by searching. In particular, if there is only one value in the array of the x coordinates, it does not need to be marked and directly enters the loop. Until all the particle areas surrounded by the particle edges are marked. The cycle is complete. As shown in FIG. 6

Step 7: a collision detection of particles is mainly completed. Firstly, the grid area established in the step 6 is used to check whether marked points in a porous medium area intersect. For this cross-judgment method, an area corresponding to the porous medium is indexed and added with the area established in the step 6, and whether there is an abnormal value is judged, and if there is an abnormal value, it means that there is an intersection. Then, the Floyd-Warshall algorithm in the step 7 is executed, and a distance between a particle generation center, that is, a center coordinate point generated in the step 2, is judged, and a distance between the center point and a nearest marked point is calculated. This value is returned to the step 3, a random range of Fourier parameters is redefined, and then the steps 4-6 are re-executed. Through this operation, generation conditions may be met by generating particles with the center coordinates for at most two cycles.

Step 8: the particle positions that meet the collision detection and marking features are updated into the porous medium model, and the results are stored.

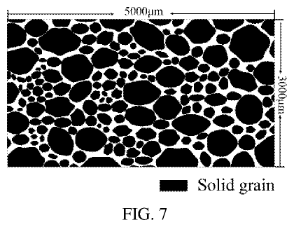

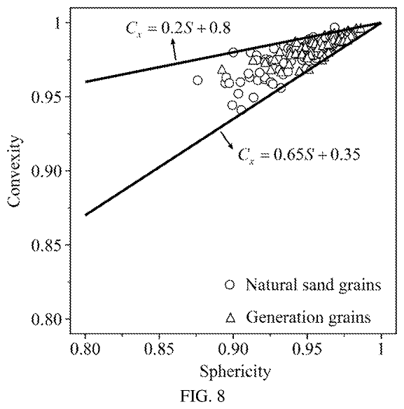

Then, the above steps are repeated until the porous medium model meets preset porosity requirements, and then the calculation is ended. Through the above calculation, 236 irregular particles are arranged in the 5000×3000 μm² of a rectangular physical domain, and a fluid domain is extracted through a Boolean operation. In order to verify an accuracy of the porous medium model, according the disclosure, 50 particles are randomly selected from the 236 generated particles, their sphericity and convexity are calculated, and then compared with 100 natural sand particles, and a good comparison result is obtained. As shown in FIG. 7 and FIG. 8.

Compared with a traditional random superposition algorithm, the method provided by the disclosure reduces complexity and an iteration ordinal number of the algorithm. Based on a computer with a 3.4 GHz processor, it takes about 30 seconds to generate a porous medium model with porosity=0.4 using the proposed method, while it takes about 3 hours using the traditional random superposition algorithm. Especially, when the porosity of the generated model is low (for example, porosity=0.2), a running time of the traditional algorithm becomes very long (more than 24 hours), while the proposed method takes only 2 hours to complete. A reason why the calculation time gap is so large is that most of the calculation time of the traditional algorithm is spent on finding an appropriate generation position. For a model with small porosity, an execution efficiency of the proposed method is still high, because a selected generation position is effective for each execution and particle parameters are adjusted based on results of a contact detection. Moreover, when grid resolution is large enough, a theoretical minimum porosity of the generated model tends to zero. Using the proposed method to generate a model with low porosity may be achieved by improving the grid resolution. Increasing the grid resolution may lead to a lot of calculation consumption. However, a generation process of the model is optimized reasonably through segmentation. In a case of smaller grid resolution, positions of large particles may be arranged, and calculation results may be used as an input of a next generation, and the grid resolution may be increased to arrange small particles. Theoretically, the algorithm may generate a connected porous medium structure that is infinitely close to 0%. But it may cause a loss of operation time. Based on a test of the disclosure, this method is efficient for porous medium models with porosity greater than 8%, and is suitable for generating porous models of medium permeability and high permeability reservoirs.

### Embodiment 3

The disclosure also provides a system for randomly generating a porous medium model based on Fourier series, including a model acquisition module, an initialization module, a discrete module, an edge extraction module, a filling module, a collision detection module, an update module, a model generation module and an output module.

The model acquisition module is used for setting a porosity, resolution and a size of a pre-generated porous medium model.

The initialization module is used for initializing the porous medium model and generating position information of particles; parameters of the initialization include a model porosity and a model size; and the position information includes position coordinates and rotation angles of particle centers;

The discrete module is used for generating and combining Fourier parameters based on setting of the initialization module and a Fourier series expansion, obtaining a particle profile parameter equation of a porous medium, and performing discretization to obtain discrete particle profile data; and a process of obtaining the parameter equation is as follows:
establishing a global coordinate system representing a pore space and a local coordinate system representing a particle space;
based on the local coordinate system, expanding the Fourier series to obtain a single-valued function;
based on the single-valued function, obtaining a particle profile parameter equation of the local coordinate system;
converting the particle profile parameter equation of the local coordinate system into a particle profile parameter equation of the global coordinate system; and
based on the particle profile parameter equation of the global coordinate system, obtaining the particle profile parameter equation of the porous medium.

The edge extraction module is used for carrying out grid mapping on the discrete particle profile data and extracting particle profile edges.

The filling module is used for carrying out local marking and area search on the particle profile edges to obtain filled particles.

The collision detection module is used for carrying out a collision detection on the filled particles and preset particles, and determining effectiveness of a particle generation position.

The update module is used for presetting a cyclic pop-up condition, and if a judgment result of the collision detection module meets the cyclic pop-up condition, executing the model generation module; otherwise, updating the Fourier parameters and returning to the update module.

The model generation module is used for adding a particle configuration meeting the cyclic pop-up condition to a model generation area and storing parameters.

The output module is used for determining whether the porous medium model generated in the model generation module meets preset generation requirements, and if so, outputting a porous medium model; otherwise, returning to the initialization module.

The above-mentioned embodiments are only descriptions of preferred modes of the disclosure, and do not limit a scope of the disclosure. Under a premise of not departing from a design spirit of the disclosure, various modifications and improvements made by ordinary technicians in the field to the technical schemes of the disclosure shall fall within the scope of protection determined by claims of the disclosure.

What is claimed is:

1. A method for randomly generating a porous medium model for simulating geological reservoirs, implemented in a computer system using a set of computer-executable instructions, comprising following steps:
S1, drilling various spatial positions in the geological reservoir to determine geological reservoir-related behavior information and collecting measurements of plurality of mined samples using a data collection device in the laboratory;
S2, setting a porosity, resolution and a size of a pre-generated porous medium model designed for a specific geological reservoir;
S3, initializing the porous medium model by incorporating a geological data and generating position information of particles based on said data;
S4, performing a Fourier series expansion based on the setting of the S2 and the geological data to obtain a particle profile parameter equation of a porous medium, and discretizing to obtain discrete particle profile data;
S5, performing grid mapping on the discrete particle profile data to extract particle profile edges;
S6, carrying out local marking and area search on the particle profile edges to obtain filled particles;
S7, carrying out a collision detection on the filled particles and preset particles, and determining effectiveness of a particle generation position;
S8, presetting a cyclic pop-up condition, and using the computer to determine an optimal particle shape in relation to the discrete particle profile data and porosity with Fourier series expansion, then adding a particle configuration meeting the cyclic pop-up condition to a model generation area, and storing parameters; and
S9, constructing the porous medium model with the optimal particle shape using the computer, and repeating the porous medium model generated in the S8 until meets preset generation requirements, and outputting a porous medium model, and at least one of recording and tabulating results of the repeated model and calculating.

2. The method for randomly generating the porous medium model for simulating geological reservoirs according to claim 1, wherein,
parameters of the initialization comprising a model porosity and a model size; and
the position information comprising a position coordinates and a rotation angles of particle centers.

3. The method for randomly generating the porous medium model for simulating geological reservoirs according to claim 1, wherein a method of obtaining the particle profile parameter equation is:
establishing a global coordinate system representing a pore space and a local coordinate system representing a particle space;
based on the local coordinate system, performing the Fourier series to obtain a single-valued function;
based on the single-valued function, obtaining a particle profile parameter equation of the local coordinate system;
converting the particle profile parameter equation of the local coordinate system into a particle profile parameter equation of the global coordinate system; and
based on the particle profile parameter equation of the global coordinate system, obtaining the particle profile parameter equation of the porous medium.

4. The method for randomly generating the porous medium model for simulating geological reservoirs according to claim 3, wherein a formula of the single-valued function is:
$$r ( {θ}^{′} ) = {a}_{0} + {\sum }_{n = 1}^{N} [ {a}_{n} cos ( n {θ}^{′} ) + {b}_{n} sin ( n {θ}^{′} ) ] ,$$
wherein r represents a radius from a particle center point P to a point P′ on the profile; θ′ represents a polar angle of a radius of an x′ axis of the local coordinate system x′-y′, 0≤θ′<2π; a₀, aₙ, bₙ, and N are Fourier coefficients.

5. The method for randomly generating the porous medium model for simulating geological reservoirs according to claim 3, wherein the particle profile parameter equation of the local coordinate system is as follows:
x′(θ′)=r(θ′)cos θ′
y′(θ′)=r(θ′)sin θ′
the particle profile parameter equation of the global coordinate system is as follows:
$$x = {x}_{p} + {x}^{′} ( {θ}^{′} ) cos ( {θ}_{0} ) = {x}_{p} + r ( {θ}^{′} ) cos ( θ )$$
$$y = {y}_{p} + {y}^{′} ( {θ}^{′} ) sin ( {θ}_{0} ) = {y}_{p} + r ( {θ}^{′} ) sin ( θ )$$
wherein xₚ and yₚ are translation distances of the particle center in the global coordinate system, a variable θ₀ is an angle from the global coordinate system x axis to the local coordinate system x′ axis, and θ=θ₀+θ′ represents a polar angle of a point in the global coordinate system.

6. The method for randomly generating the porous medium model for simulating geological reservoirs according to claim 1, wherein a method for the collision detection is:
adding a porous medium corresponding area and a grid area in a matrix, and determining whether an abnormal value exists; and
if the abnormal value exists, there is a local intersection of marked points to realize the collision detection.

7. The method for randomly generating porous medium model for simulating geological reservoirs according to claim 1, wherein the S7, the Fourier parameters are updated by adopting a Floyd-Warshall algorithm;
an iterative equation of the Floyd-Warshall algorithm is:
$$\{ \begin{matrix}{u}_{i , i}^{( 1 )} = 0 \\ {u}_{j , j}^{( 1 )} = {w}_{i , j} , i \neq j \\ {u}_{i , j}^{( k + 1 )} = min \{ {u}_{i , j}^{( k )} , {u}_{i , k}^{( k )} + {u}_{k , j}^{( k )} \} , i , j , k = 1 , 2 , … , n\end{matrix}$$
wherein w_{i,j} represents a path length value from a node i to a node j.

8. The method for randomly generating the porous medium model for simulating geological reservoirs according to claim 7, wherein a solution method for the iterative equation is:
S71: initializing equation parameters, k=0, and letting p_{i,j}⁽¹⁾=j, u_{i,j}⁽¹⁾=0 and u_{i,j}⁽¹⁾=w_{i,j} for all nodes i and j, where i≠j; if there is no arc connection between the node i and the node j, then w_{i,j}=∞;
S72: letting k=k+1, for all inflow nodes i and outflow nodes j adjacent to a k node, if u_{i,j}^{(k)}≤u_{i,k}^{(k)}+u_{k,j}^{(k)}, letting p_{i,j}^{(k)}=p_{i,j}^{(k)}, u_{i,j}^{(k+1)}=p_{i,j}^{(k)}; otherwise, letting p_{i,j}^{(k+1)}=p_{i,j}^{(k)}, u_{i,j}^{(k+1)}=u_{i,k}^{(k)}+u_{k,j}^{(k)}; and
S73: if k=n, completing a solution; otherwise, returning to the S72.

9. A system for randomly generating a porous medium model for simulating geological reservoirs, implemented in a computer system using a set of computer-executable instructions, comprising a model acquisition module, an initialization module, a discrete module, an edge extraction module, a filling module, a collision detection module, an update module, a model generation module and an output module;
the model acquisition module is used for setting a porosity, resolution and a size of a pre-generated porous medium model;
the initialization module is used for initializing the porous medium model and generating position information of particles; parameters of the initialization comprise a model porosity and a model size; and the position information comprises position coordinates and rotation angles of particle centers;
the discrete module is used for generating and combining Fourier parameters based on setting of the initialization module and a Fourier series expansion, obtaining a particle profile parameter equation of a porous medium, and performing discretization to obtain discrete particle profile data; and a process of obtaining the parameter equation is:
establishing a global coordinate system representing a pore space and a local coordinate system representing a particle space;
based on the local coordinate system, expanding the Fourier series to obtain a single-valued function;
based on the single-valued function, obtaining a particle profile parameter equation of the local coordinate system;
converting the particle profile parameter equation of the local coordinate system into a particle profile parameter equation of the global coordinate system; and
based on the particle profile parameter equation of the global coordinate system, obtaining the particle profile parameter equation of the porous medium;
the edge extraction module is used for carrying out grid mapping on the discrete particle profile data and extracting particle profile edges;
the filling module is used for carrying out local marking and area search on the particle profile edges to obtain filled particles;
the collision detection module is used for carrying out a collision detection on the filled particles and preset particles, and determining effectiveness of a particle generation position;
the update module is used for presetting a cyclic pop-up condition, and if a judgment result of the collision detection module meets the cyclic pop-up condition, executing the model generation module; otherwise, updating the Fourier parameters and returning to the update module;
the model generation module is used for adding a particle configuration meeting the cyclic pop-up condition to a model generation area and storing the parameters, and constructing the porous medium model with an optimal particle shape using the computer; and the output module is used for determining whether the porous medium model generated in the model generation module meets preset generation requirements, and if so, outputting a porous medium model; otherwise, returning to the initialization module.
